(19) United States
(12) Patent Application Publication
(10) Pub. No.: US 2004/0098157 A1
(43) Pub. Date: May 20, 2004

(54) Method, apparatus and system for storing product documentation in a memory device affixed to a product

(75) Inventors: Eugene P. Sabini, Skaneateles, NY (US); Jerome A. Lorenc, Seneca Falls, NY (US); Jeremiah D. Quill, Auburn, NY (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: ITT Manufacturing Enterprises, Inc., Wilmington, DE

(21) Appl. No.: 10/294,463

(22) Filed: Nov. 14, 2002

(51) Int. Cl. G06F 19/00

(52) U.S. Cl. 700/115

(57) ABSTRACT

A method, apparatus or system is provided for storing information related to a product in a memory device attached thereto, that features the step of gathering, assembling and storing in the memory device product documentation or a link to a website containing the product documentation. The link includes an address to the website. The product documentation includes sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof. The memory device may also store pedigree information, such as either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof.

### BACKGROUND OF THE INVENTION

1. Field of Invention

The present invention relates to a method and apparatus for providing product information on a product; and more particularly relates to a method and apparatus for doing the same on a pump product.

2. Description of Related Art

It is know in the art that almost all rotating equipment has some sort of flat printable/punchable nameplate. On the nameplate is some important pedigree information about the rotating equipment it is mounted to. The pedigree information may include: the manufacturer's name, model of equipment, size of equipment, equipment serial number, equipment maximum speed and rating information, bearing sizes, electrical requirement such as voltage, current, frequency, number of phases, lubrication requirements, gear ratios, maximum temperature limits, types of fluids handled, etc. These nameplates are typically printed, stamped, laser, or chemically etched affixed onto the rotating equipment body itself or onto a plate that is fastened to the equipment body. In either case, the information is subjected to the surrounding conditions that could corrode, cover, or somehow make the information unintelligible. The amount of information included on the nameplate is limited and in most cases insufficient to the end user. This requires research into hard copies of other product documentation if such are even readily available.

Moreover, it is also known to affix an electronic memory device onto rotary equipment that contains the aforementioned pedigree information. However, such known electronic memory devices do not store larger product documentation files like purchasing files, test data files, repair parts lists, etc. Because of this, this product documentation is typically send to an end user by hardcopy. One problem in the industry using this approach is that the end user typically archives different product documentation in different departments within the company. For example, purchasing documentation may be archived in the purchasing department, test data documentation may be archived with the engineers, and repair parts lists documentation may be archived in the machine shop. In view of this, there is a need in the industry for a centralized approach for providing product documentation to the end user so that the end user can quickly gain access to the product documentation when needed.

The present invention provides a solution to this need.

### SUMMARY OF INVENTION

In its broadest sense, the present invention provides a new and unique method, apparatus and/or system for storing information related to a product in a memory device attached thereto, that features storing in the memory device product documentation, a link to a website containing the product documentation, or a combination thereof. The link includes an address to the website.

The invention overcomes all of the shortcomings of the known prior art equipment nameplate and electronic storage devices. According the invention, all product information and product documentation is stored electronically on the memory device that may be housed in an environmentally sealed canister (usually stainless steel). The canister is typically about the size of a US Nickel. The amount of information that is stored in the memory device far exceeds the information that is stored on the known prior art equipment nameplates or electronic storage device, which merely included basic pedigree information about the product. In addition to the typical pedigree information that is stored in the prior art memory device, the memory device of the present invention stores voluminous product documentation or a link for accessing the same of a website. The product documentation includes: sales literature, performance (Test Data) or equipment selected data/curves; bill of material and repair parts list; other product documents; hyperlinks to: (resident on smart nameplate, residing in computer or Distributed Control System (DCS) via the internet; installation and operation manuals (IOM); product bulletin; product and repair contact list; equipment drawings; purchase requisition of repair parts orders created, issued and submitted via Internet or e-mail; factory work and stock order generation for printout or submittal; update rotating equipment historian (on smart nameplate, computer or Internet).

This invention also features using a software program/process of gathering product information and documentation from one or more computer or input devices, assembling all of the product information and documentation into a database file that can be downloaded into the memory device located on the specific product, such as a rotating piece of equipment. It additionally uses a software program/process of retrieving the product information and documentation from the memory chip device and presenting it to an end user in an easily usable format. The retrieval software program will have the capability to link via Internet, fax or modems.

The invention is shown and described in relation to a pump application, although the invention has applicability in relation to other type of equipment. For example, the invention may be used to replace classic nameplates on rotating equipment such as: electrical motors, turbines, gear boxes, compressors, fans, etc., as well as the known memory device which merely stores pedigree information about the product. Product documentation from files such as order entry file, pump test floor file, bill of materials file, recommended repair parts file, documentation files is all accessed and gathered by the software program/process. It is assimilated into a form that can be downloaded into the memory device located on the product.

The software program is supplied to the end user with the necessary hardware to read the memory device. This software program accesses all of the information stored on the memory chip. It also formats and presents it to the end user. The invention also provides the capability to link the end user via Internet to web sites that have all of the necessary product documentation, including technical and sales information that are not stored in the memory device, for the pump product selected. It has the ability to generate and send parts orders, work requests and update historian files. The historian files may even reside on the memory chip and can be modified by the end user.

The invention also features selectively updating the product documentation on the website as the evolution, development or understanding of the product evolves over time. One advantage of linking the end user to a website for product documentation is that product information and documentation available on the website can be modified and/or augmented from to time to time as the evolution, development or understanding of the product evolves over time. In the prior art, the information stored in the memory device on the product of the end user is basically static and unchanging.

### BRIEF DESCRIPTION OF THE DRAWING

The drawing, not drawn to scale, includes the following Figures:

FIG. 1 is a diagram of a pump having a memory device affixed thereon in accordance with the present invention.

FIG. 2 is a diagram of a system having a main computer, one or more secondary computers or input devices and a memory device affixed on a product in accordance with the present invention.

### DETAILED DESCRIPTION OF INVENTION

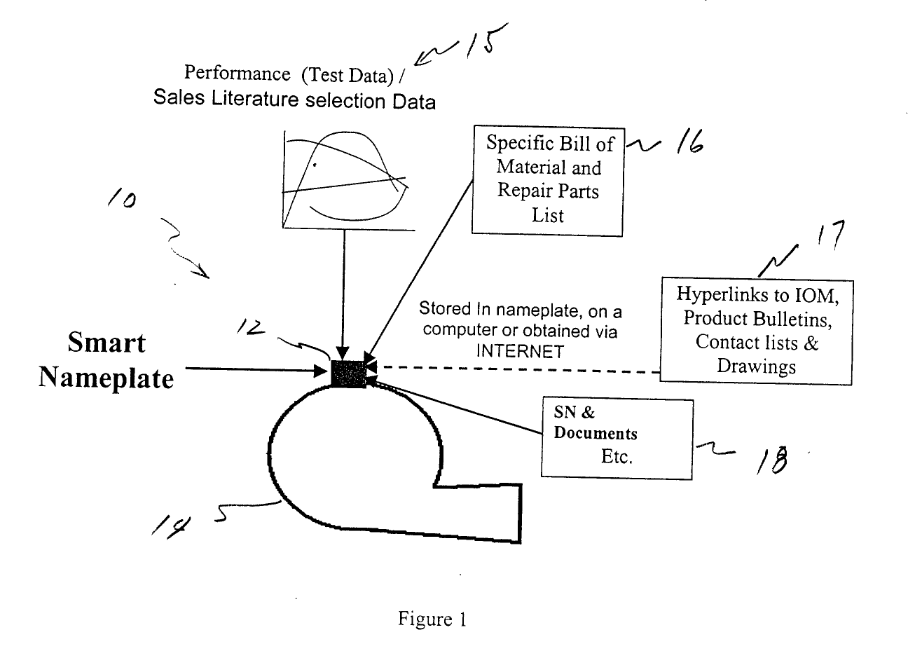

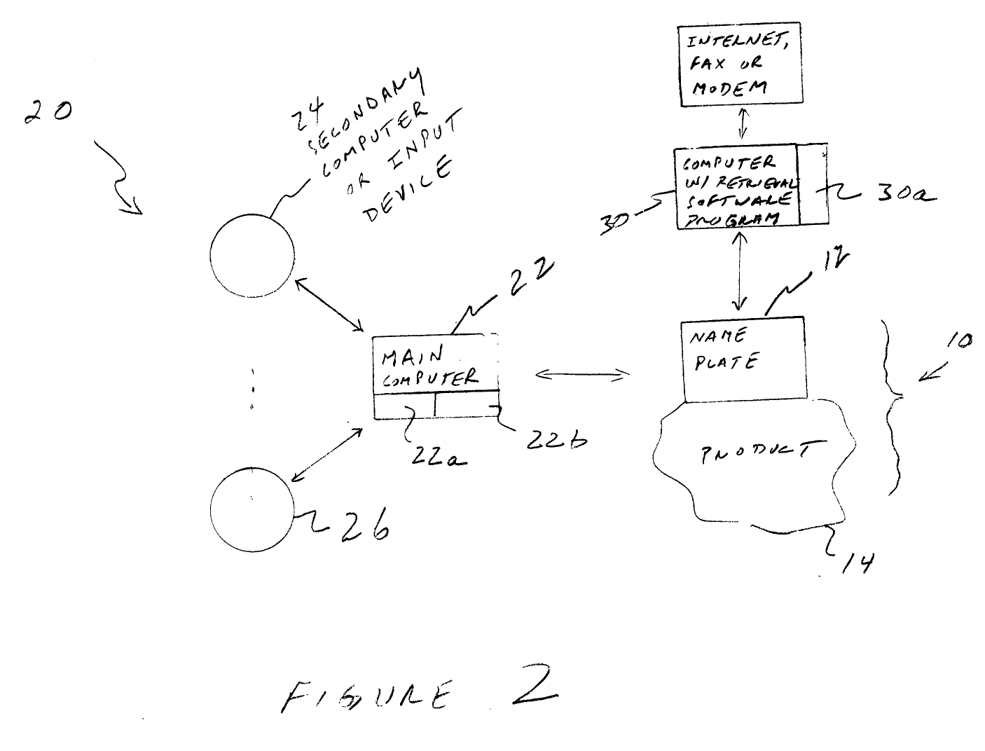

FIG. 1 shows an apparatus generally indicated as 10 having a memory device 12 attached thereto for storing information related to a product 14. In accordance with the invention, the memory device 12 stores either product documentation 15, 16, a link 17 to a website containing the product documentation, or a combination thereof, as well as the manner or providing the product documentation 15, 16 and/or the link 17 to and from the memory device 12, which is discussed in more detail in relation to FIG. 2. As shown, the product 14 is a pump such as a centrifugal pump, although the scope of the invention is intended to include other types of products or equipment such as an electrical motor, a turbine, a gear box or a compressor fan. The memory device 12 for storing information is known in the art and commercially available. Ibutton is an example of such a product (See www.ibutton.com) manufactured by Dallas Semiconductor doing business in Dallas, Tex. The website containing the product documentation 15, 16 would typically be a company website that makes or distributes the product 14, although the scope of the invention is intended to include one or more links to one or more other websites, such as a manufacturer, distributor or service provider of a principal sub-component of the product. The link 17 stored in the memory device 12 may include one or more addresses to the one or more websites. The product documentation stored on the website may be selectively updated as the evolution, development or understanding of the product evolves over time.

The product documentation 15, 16 may include sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof. The product documentation 17 includes data files that typically would require large blocks of memory, including multiple megabytes or more of memory. The scope of the invention is not intended to be limited to specific product documentation stored on the memory device 12 or available on the website.

The memory device 12 may also store other information such as pedigree information 18 about the product 14, including either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof. The pedigree information 18 would include various data files, each having relatively small memory requirements compared to the product documentation.

FIG. 2 shows a system generally indicated as 20 in accordance with the invention that includes the product 10 with the memory device 12 attached thereto for storing information related to the product 14. As shown, the system 20 may include a computer node 22 coupled to other computers or input devices 24, 26. The computer node 22 has a software gathering program 22a for gathering the product documentation or link from the other computers or the input devices 24, 26, as well as a software program 22b for providing the product information or the link to the memory device 12. The system 20 may also include an end user computer node 30 having a retrieval software program for retrieving the product information from the memory device 12, via the website on the Internet, or a combination thereof.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

We claim:

1. A method for storing information related to a product in a memory device attached thereto, characterized in that the method comprises the step of:
storing in the memory device product documentation, a link to a website containing the product documentation or a combination thereof.

2. A method according to claim 1, wherein the link includes an address to the website.

3. A method according to claim 1, wherein the product documentation includes sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof.

4. A method according to claim 1, wherein the information includes pedigree information, such as either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof.

5. A method according to claim 1, wherein the product includes a pump, an electrical motor, a turbine, a gear box, a compressor, or a fan.

6. A method according to claim 1, wherein the method comprises a step for gathering with a computer node having a software gathering program the product documentation or link from other computers or input devices coupled thereto.

7. A method according to claim 1, wherein the method comprises a step for providing with a computer node having a software program the product documentation to the memory device.

8. A method according to claim 1, wherein the method comprises a step for retrieving with a computer node having a retrieval software program the product documentation from the memory device or via the website on the Internet.

9. An apparatus having a memory device attached thereto for storing information related to the apparatus, characterized in that the memory device stores product documentation, a link to a website containing the product documentation, or a combination thereof.

10. An apparatus according to claim 9, wherein the link includes an address to the website.

11. An apparatus according to claim 9, wherein the product documentation includes sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof.

12. An apparatus according to claim 9, wherein the information includes pedigree information, such as either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof.

13. An apparatus according to claim 9, wherein the apparatus includes a pump, an electrical motor, a turbine, a gear box, compressor, or a fan.

14. An apparatus according to claim 9, wherein the memory device is adapted for receiving the product documentation or link from a computer node having a software gathering program for gathering the product documentation or link from other computers or input devices coupled thereto.

15. A system having a product with a memory device attached thereto for storing information related to the product, and a computer node coupled to other computers or input devices coupled thereto, characterized in that the memory device stores product documentation, a link to a website containing the product documentation, or a combination thereof.

16. A system according to claim 15, wherein the link includes an address to the website.

17. A system according to claim 15, wherein the product documentation includes sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof.

18. A system according to claim 15, wherein the information includes pedigree information, such as either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof.

19. A system according to claim 15, wherein the product includes a pump, an electrical motor, a turbine, a gear box, a compressor, or a fan.

20. A system according to claim 15, wherein the computer node has a software gathering program for gathering the product documentation or link from the other computers or the input devices.

21. A system according to claim 15, wherein the computer node has a software program for providing the product documentation or the link to the memory device.

22. A system according to claim 15, wherein the system comprises an end user computer node having a retrieval software program for retrieving the product documentation from the memory device or via the website on the Internet.

23. A method according to claim 1, wherein the method comprises a step for selectively updating the product documentation on the website as the evolution, development or understanding of the product evolves over time.

24. A method for storing information related to a product in a memory device attached thereto, characterized in that the method comprises the step of:
gathering, assembling and storing in the memory device product documentation, a link to a website containing the product documentation or a combination thereof.

25. A method according to claim 24, wherein the link includes an address to the website.

26. A method according to claim 24, wherein the product documentation includes sales literature, a purchase order, an order entry, performance or test data, equipment selected data/curves, bill of material, repair parts list, installation and operation manuals (IOM), maintenance manuals, product bulletins, product and repair contact lists, equipment drawings, purchase requisition of repair parts orders, factory work and stock orders, product history, or a combination thereof.

27. A method according to claim 24, wherein the information includes pedigree information, such as either the manufacturer's name, model of equipment, size of equipment, equipment serial number, equipment maximum speed and rating information, bearing sizes, electrical requirements such as voltage, current, frequency, name of phases, lubrication requirements, gear ratios, maximum temperature limits, type of fluids handled, or a combination thereof.

28. A method according to claim 24, wherein the product includes a pump, an electrical motor, a turbine, a gear box, a compressor, or a fan.

29. A method according to claim 24, wherein the step for gathering includes using a computer node having a software gathering program the product documentation or link from other computers or input devices coupled thereto.

30. A method according to claim 24, wherein the method comprises a step for providing with a computer node having a software program the product documentation to the memory device.

31. A method according to claim 24, wherein the method comprises a step for retrieving with a computer node having a retrieval software program the product documentation from the memory device or via the website on the Internet.
